(19) United States
(12) Patent Application Publication
(10) Pub. No.: US 2026/0349744 A1
(43) Pub. Date: Nov. 5, 2026

(54) CONTROL CHIP AND OPERATION METHOD THEREOF

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/209,803

(22) Filed: May 16, 2025

(30) Foreign Application Priority Data
May 5, 2025 (TW) 114116749

(51) Int. Cl. G06F 9/4401

(52) U.S. Cl. CPC G06F 9/4401

(57) ABSTRACT

A control chip and an operation method thereof. The control chip includes a basic input and output image file controller and a connection interface. The basic input and output image file controller is coupled to a first read-only memory and a second read-only memory. The connection interface is coupled to the basic input and output image file controller. The first read-only memory stores a first BIOS image file. The second read-only memory stores a second BIOS image file. The basic input and output image file controller determines whether a trigger signal is received. When the basic input and output image file controller receives the trigger signal, the basic input and output image file controller reads a third BIOS image file from the connection interface. The basic input and output image file controller updates the third BIOS image file to at least one of the first and second read-only memories.

### CROSS-REFERENCE TO RELATED APPLICATION

This application claims the priority benefit of Taiwan application serial no. 114116749, filed on May 5, 2025. The entirety of the above-mentioned patent application is hereby incorporated by reference herein and made a part of this specification.

### BACKGROUND

### Technical Field

The disclosure relates to a chip, and particularly relates to a control chip and an operation method thereof.

### Related Art

Currently, when the basic input output system (BIOS) is damaged or fails, since part of the functional circuits of the computer system may not be able to start, it is therefore not possible to write a new basic input output system into the memory that stores the basic input output system. Moreover, the conventional method for updating the basic input output system requires execution after relatively complicated related settings.

### SUMMARY

The disclosure provides a control chip and an operation method thereof, which may update the basic input output system image file stored in at least one of the first read-only memory and the second read-only memory.

The control chip of the disclosure includes a basic input and output image file controller and a connection interface. The basic input and output image file controller is coupled to a first read-only memory and a second read-only memory. The connection interface is coupled to the basic input and output image file controller. The first read-only memory is configured to store a first basic input output system (BIOS) image file. The second read-only memory is configured to store a second BIOS image file. The basic input and output image file controller is configured to determine whether a trigger signal is received. When the basic input and output image file controller receives the trigger signal, the basic input and output image file controller reads a third BIOS image file from the connection interface. The basic input and output image file controller updates the third BIOS image file to at least one of the first read-only memory and the second read-only memory.

The operation method of the disclosure is adapted to a control chip. The control chip includes a basic input and output image file controller and a connection interface. The basic input and output image file controller is coupled to a first read-only memory and a second read-only memory. The first read-only memory is configured to store a first basic input output system (BIOS) image file. The second read-only memory is configured to store a second BIOS image file. The connection interface is coupled to the basic input and output image file controller. The operation method includes steps as follows. Whether a trigger signal is received is determined through the basic input and output image file controller. When the basic input and output image file controller receives the trigger signal, a third BIOS image file is read from the connection interface through the basic input and output image file controller. Also, the third BIOS image file is updated to at least one of the first read-only memory and the second read-only memory through the basic input and output image file controller.

Based on the above, the control chip and the operation method thereof of the disclosure may, according to whether the external trigger signal is received, determine to update the BIOS image file stored in at least one of the first read-only memory and the second read-only memory.

To make the foregoing features and advantages of the disclosure more comprehensible, embodiments are specifically provided below, with detailed explanations in conjunction with the accompanying drawings as follows.

### BRIEF DESCRIPTION OF THE DRAWINGS

FIG. 1 is a circuit schematic diagram of a control chip and system architecture according to an embodiment of the disclosure.

FIG. 2 is a flowchart of an operation method of a control chip according to an embodiment of the disclosure.

FIG. 3 is a circuit schematic diagram of a control chip and system architecture according to another embodiment of the disclosure.

### DESCRIPTION OF THE EMBODIMENTS

In order to make the content of the disclosure more comprehensible, embodiments are specifically provided below as examples that the disclosure can indeed be implemented based on. Additionally, wherever possible, the same reference numerals used in the drawings and embodiments represent the same or similar components/elements/steps.

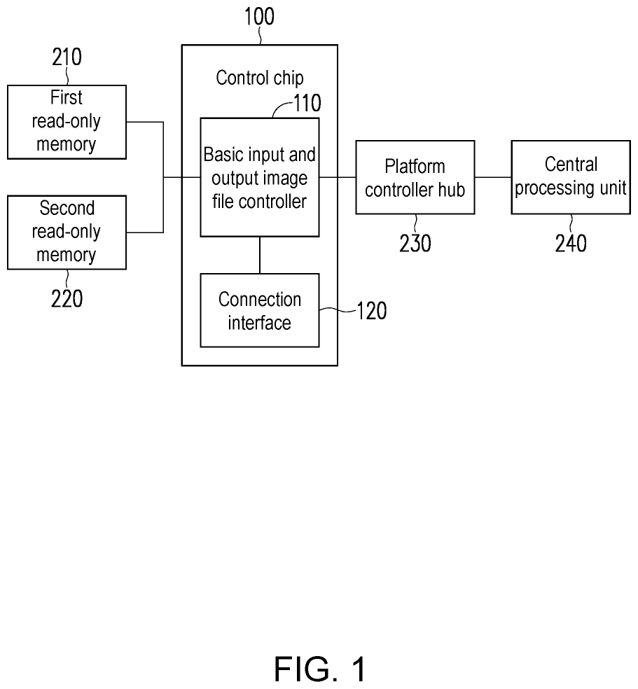

FIG. 1 is a circuit schematic diagram of a control chip and system architecture according to an embodiment of the disclosure. Referring to FIG. 1, a control chip 100 includes a basic input and output image file controller 110 (or BIOS image file controller) and a connection interface 120. In this embodiment, the basic input and output image file controller 110 is coupled to the connection interface 120, a first read-only memory (ROM) 210, and a second read-only memory 220. The basic input and output image file controller 110 is further coupled to a central processing unit (CPU) 240 through a platform controller hub (PCH) 230. The memory may be a read-only memory (ROM), but the disclosure is not limited thereto.

In this embodiment, the control chip 100, the first read-only memory 210, the second read-only memory 220, the platform controller hub 230, and the central processing unit 240 may be disposed on the same board (for example, motherboard) and may be implemented in a computer device. In this embodiment, the first read-only memory 210 is configured to store a first basic input output system (BIOS) image file, and the second read-only memory 220 is configured to store a second BIOS image file. The version of the first BIOS image file and the version of the second BIOS image file may be the same or different.

In this embodiment, when the central processing unit 240 performs a boot operation, the control chip 100 may read the first read-only memory 210 or the second read-only memory 220 to obtain the first BIOS image file or the second BIOS image file. Also, the central processing unit 240 may read and execute the first BIOS image file or the second BIOS image file through the platform controller hub 230 to perform boot operations such as power-on self-test (POST), hardware initialization, hardware boot loading, and system settings. The control chip 100 may selectively read the first read-only memory 210 or the second read-only memory 220 to provide the BIOS image file to the central processing unit 240. Alternatively, the control chip 100 may also select the BIOS image file with the latest program version to execute, and the disclosure is not limited thereto.

In an embodiment, when the BIOS image file stored in one of the first read-only memory 210 and the second read-only memory 220 is damaged (that is, the system cannot successfully boot, resulting in the operating system failing to start normally) and cannot be used for the boot operation, the control chip 100 may read the BIOS image file stored in the other one of the first read-only memory 210 and the second read-only memory 220 to perform the boot operation. In this regard, the BIOS image file may be unusable due to factors such as file damage, memory damage, or failure of a previous version update, causing the central processing unit 240 to fail to boot successfully. In other words, the other one of the first read-only memory 210 and the second read-only memory 220 may serve as a backup, effectively increasing the probability of successful booting of the central processing unit 240.

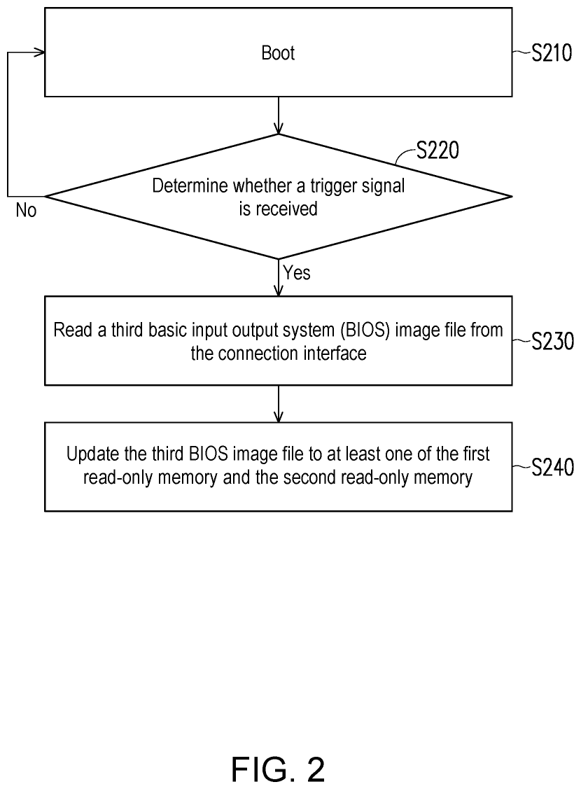

FIG. 2 is a flowchart of an operation method of a control chip according to an embodiment of the disclosure. Referring to FIG. 1 and FIG. 2, the control chip 100 may execute Steps S210 to S240 as follows. In Step 210, the central processing unit 240 may perform booting, and the power system of the computer device may supply power to the control chip 100. In Step S220, the basic input and output image file controller 110 may determine whether a trigger signal is received. If not, the basic input and output image file controller 110 may execute Step S220 again after a preset time length to re-determine whether the trigger signal is received. If yes, in Step S230, the basic input and output image file controller 110 may read a third BIOS image file from the connection interface 120. The connection interface 120 may be coupled to an external storage device storing the third BIOS image file. In Step S240, the basic input and output image file controller 110 may update the third BIOS image file to at least one of the first read-only memory 210 and the second read-only memory 220.

In this embodiment, the basic input and output image file controller 110 may further include an internal buffer. The basic input and output image file controller 110 may first read the third BIOS image file from the external storage device through the connection interface 120, and temporarily store the third BIOS image file in the internal buffer. Then, the basic input and output image file controller 110 updates the third BIOS image file temporarily stored in the internal buffer to at least one of the first read-only memory 210 and the second read-only memory 220. In this embodiment, the basic input and output image file controller 110 may overwrite at least one of the first BIOS image file and the second BIOS system image file with the third BIOS image file. In this embodiment, the basic input and output image file controller 110 may determine the update method of the BIOS image file according to firmware settings or the type of trigger signal.

In an embodiment, the basic input and output image file controller 110 may be preset to update the third BIOS image file only to the first read-only memory 210 or the second read-only memory 220. In an embodiment, the basic input and output image file controller 110 may sequentially update the third BIOS image file to the first read-only memory 210 and the second read-only memory 220 according to a preset update order. Alternatively, the basic input and output image file controller 110 may first update the second read-only memory 220, and then update the first read-only memory 210. In an embodiment, the basic input and output image file controller 110 may also be preset to simultaneously update the third BIOS image file to the first read-only memory 210 and the second read-only memory 220.

In an embodiment, the basic input and output image file controller 110 may also determine the signal type of the trigger signal to determine the update method. For example, when the basic input and output image file controller 110 determines that a first trigger signal is received, the basic input and output image file controller 110 may only update the third BIOS image file to the first read-only memory 210. When the basic input and output image file controller 110 determines that a second trigger signal is received, the basic input and output image file controller 110 may only update the third BIOS image file to the second read-only memory 220. When the basic input and output image file controller 110 determines that a third trigger signal is received, the basic input and output image file controller 110 may simultaneously update the third BIOS image file to the first read-only memory 210 and the second read-only memory 220. When the basic input and output image file controller 110 determines that a fourth trigger signal is received, the basic input and output image file controller 110 may first update the third BIOS image file to the first read-only memory 210, and then update the third BIOS image file to the second read-only memory 220.

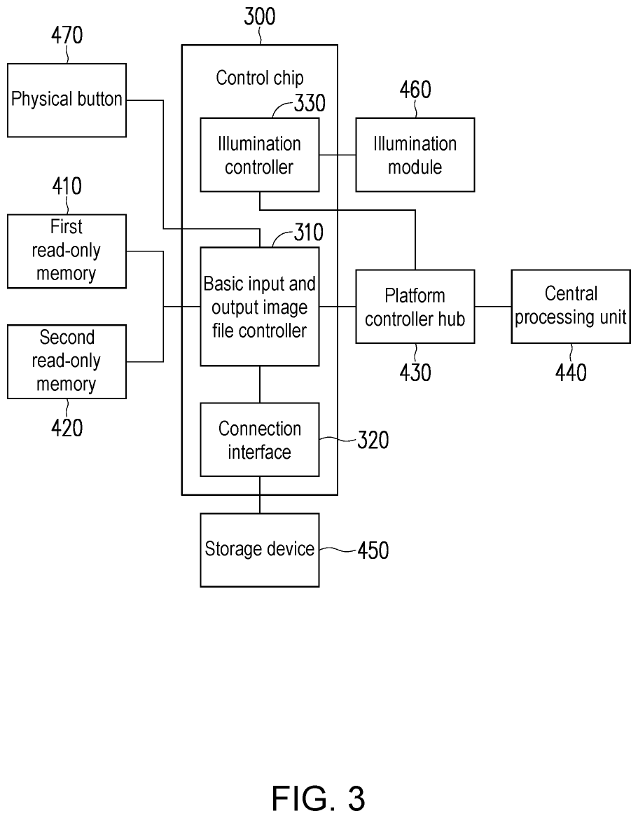

FIG. 3 is a circuit schematic diagram of a control chip and system architecture according to another embodiment of the disclosure. Referring to FIG. 3, a control chip 300 includes a basic input and output image file controller 310, a connection interface 320, and an illumination controller 330. In this embodiment, the basic input and output image file controller 310 is coupled to the connection interface 320, a first read-only memory 410, and a second read-only memory 420. The basic input and output image file controller 310 is further coupled to a central processing unit 440 through a platform controller hub 430. In this embodiment, the connection interface 320 may be coupled to an external storage device 450. In this embodiment, the basic input and output image file controller 310 is further coupled to an external physical button 470.

In this embodiment, the connection interface 320 may be a universal serial bus (USB) interface. The storage device 450 may be a USB storage device. The storage device 450 is configured to store the third BIOS image file. In this embodiment, the basic input and output image file controller 310 may receive the trigger signal output by the physical button 470. In this embodiment, the physical button 470 may be disposed on the control chip 300, or the physical button 470 and the control chip 300 may be placed on the same board (for example, motherboard). In an embodiment, the physical button 470 may also be connected to the control chip 300 through physical wiring, and be externally located at other positions outside the motherboard.

Compared to the embodiment of FIG. 1, the control chip 300 further includes the illumination controller 330. In this embodiment, the illumination controller 330 may be coupled to the platform controller hub 430 and the external illumination module 460, and is configured to control the illumination module 460. The illumination module 460 may, for example, include illumination components disposed on the motherboard, computer casing, or other peripherals to provide special lighting effects. In other words, regardless of whether the central processing unit 440 successfully executes the boot process, the control chip 300 may independently control the illumination module 460 to provide, for example, specific illumination effects. In an embodiment, the illumination module 460 may, for example, include multiple RGB light emitting diodes (LED).

In an embodiment, the number of physical buttons 470 may be one. When the user operates the physical button 470 to output a trigger signal to the basic input and output image file controller 310, the basic input and output image file controller 310 may be preset to only update the third BIOS image file to the first read-only memory 410 or the second read-only memory 420. In an embodiment, when the basic input and output image file controller 310 receives the trigger signal output by the physical button 470, the basic input and output image file controller 310 may also update the third BIOS image file sequentially to the first read-only memory 410 and the second read-only memory 420 according to a preset update order. Alternatively, the basic input and output image file controller 310 may also update the second read-only memory 420 first, and then update the first read-only memory 410. In an embodiment, when the basic input and output image file controller 310 receives the trigger signal output by the physical button 470, the basic input and output image file controller 310 may also be preset to update the third BIOS image file simultaneously to the first read-only memory 410 and the second read-only memory 420.

In an embodiment, the number of physical buttons 470 may also be multiple. The basic input and output image file controller 310 may determine which trigger signal is received to determine the update method for the BIOS image file.

For example, when the user operates a first physical button to make the first physical button output a first trigger signal, the basic input and output image file controller 310 may determine that the first trigger signal is received, and the basic input and output image file controller 310 may only update the third BIOS image file to the first read-only memory 210.

When the user operates a second physical button to make the second physical button output a second trigger signal, the basic input and output image file controller 310 may determine that the second trigger signal is received, and the basic input and output image file controller 310 may only update the third BIOS image file to the second read-only memory 220.

When the user operates a third physical button to make the third physical button output a third trigger signal, the basic input and output image file controller 310 may determine that the third trigger signal is received, and the basic input and output image file controller 310 may update the third BIOS image file simultaneously to the first read-only memory 410 and the second read-only memory 420.

When the user operates a fourth physical button to make the fourth physical button output a fourth trigger signal, the basic input and output image file controller 310 may determine that the fourth trigger signal is received, and the basic input and output image file controller 310 may first update the third BIOS image file to the first read-only memory 410, and then update the third BIOS file to the second read-only memory 420.

Therefore, even when the computer system cannot successfully boot, as long as the control chip 300 receives system power, it may immediately update the BIOS image file of at least one of the first read-only memory 410 and the second read-only memory 420. Additionally, for other implementation details and technical descriptions of the control chip 300, reference may be made to the content of the embodiments in FIG. 1 and FIG. 2, so details will not be repeated here.

In summary, the control chip and the operation method of the disclosure may allow the user, when the computer system cannot successfully boot or in any other situation, to update the BIOS image file through the basic input and output image file controller receiving trigger signals output by physical buttons. In other words, even if all the BIOS image files stored in all memories are in an invalid state, the basic input and output image file controller may still update at least some of the memories to enable the computer device to boot normally.

For persons skilled in the art, it should be understood that various modifications and changes can be made to the disclosed embodiments without departing from the scope or spirit of the disclosure. In summary, this disclosure is intended to cover modifications and changes that fall within the scope of the appended claims and the equivalents thereof.

What is claimed is:

1. A control chip, comprising:
a basic input and output image file controller coupled to a first read-only memory and a second read-only memory; and
a connection interface coupled to the basic input and output image file controller,
wherein the first read-only memory is configured to store a first basic input output system image file, and the second read-only memory is configured to store a second basic input output system image file,
wherein the basic input and output image file controller is configured to determine whether a trigger signal is received, and in response to the basic input and output image file controller receiving the trigger signal, the basic input and output image file controller reads a third basic input output system image file from the connection interface, wherein the basic input and output image file controller updates the third basic input output system image file to at least one of the first read-only memory and the second read-only memory.

2. The control chip as claimed in claim 1, further comprising:
an illumination controller coupled to an illumination module, and configured to control the illumination module.

3. The control chip as claimed in claim 1, wherein the connection interface is a universal serial bus interface, and the connection interface is configured to be coupled to a universal serial bus storage device, wherein the universal serial bus storage device is configured to store the third basic input output system image file.

4. The control chip as claimed in claim 1, wherein the trigger signal is output by a physical button.

5. The control chip as claimed in claim 4, wherein the physical button is disposed on the control chip.

6. The control chip as claimed in claim 4, wherein the physical button and the control chip are disposed on same board.

7. The control chip as claimed in claim 1, wherein the basic input and output image file controller only updates the third basic input output system image file to the first read-only memory or the second read-only memory.

8. The control chip as claimed in claim 1, wherein the basic input and output image file controller sequentially updates the third basic input output system image file to the first read-only memory and the second read-only memory.

9. The control chip as claimed in claim 1, wherein the basic input and output image file controller simultaneously updates the third basic input output system image file to the first read-only memory and the second read-only memory.

10. The control chip as claimed in claim 1, wherein the basic input and output image file controller is further coupled to a central processing unit through a platform controller hub.

11. An operation method of a control chip, wherein the control chip comprises a basic input and output image file controller and a connection interface, the basic input and output image file controller is coupled to a first read-only memory and a second read-only memory, the first read-only memory is configured to store a first basic input output system image file, the second read-only memory is configured to store a second basic input output system image file, and the connection interface is coupled to the basic input and output image file controller, wherein the operation method comprises:
determining whether a trigger signal is received through the basic input and output image file controller;
reading a third basic input output system image file from the connection interface through the basic input and output image file controller in response to the basic input and output image file controller receiving the trigger signal; and
updating the third basic input output system image file to at least one of the first read-only memory and the second read-only memory through the basic input and output image file controller.

12. The operation method as claimed in claim 11, wherein the control chip further comprises an illumination controller, and the illumination controller is coupled to an illumination module, wherein the operation method further comprises:
controlling the illumination module through the illumination controller.

13. The operation method as claimed in claim 11, wherein the connection interface is a universal serial bus interface, and the connection interface is configured to be coupled to a universal serial bus storage device, wherein the universal serial bus storage device is configured to store the third basic input output system image file.

14. The operation method as claimed in claim 11, wherein the trigger signal is output by a physical button.

15. The operation method as claimed in claim 14, wherein the physical button is disposed on the control chip.

16. The operation method as claimed in claim 14, wherein the physical button and the control chip are disposed on same board.

17. The operation method as claimed in claim 11, wherein updating the third basic input output system image file to the at least one of the first read-only memory and the second read-only memory comprises:
updating the third basic input output system image file only to the first read-only memory or the second read-only memory.

18. The operation method as claimed in claim 11, wherein updating the third basic input output system image file to the at least one of the first read-only memory and the second read-only memory comprises:
updating the third basic input output system image file sequentially to the first read-only memory and the second read-only memory.

19. The operation method as claimed in claim 11, wherein updating the third basic input output system image file to the at least one of the first read-only memory and the second read-only memory comprises:
updating the third basic input output system image file simultaneously to the first read-only memory and the second read-only memory.

20. The operation method as claimed in claim 11, wherein the control chip is further coupled to a central processing unit through a platform controller hub.
